(19) United States
(12) Patent Application Publication
(10) Pub. No.: US 2017/0113637 A1
(43) Pub. Date: Apr. 27, 2017

(54) DEVICE FOR CONNECTING A BASE VEHICLE ELECTRICAL SYSTEM TO A, IN PARTICULAR, SAFETY-RELEVANT SUBSYSTEM

(71) Applicant: Robert Bosch GmbH, Stuttgart (DE)

(72) Inventors: Wolfgang Mueller, Stuttgart (DE); Christian Bohne, Stuttgart (DE)

(21) Appl. No.: 15/305,147

(22) PCT Filed: Mar. 23, 2015
(86) PCT No.: PCT/EP2015/056053

§ 371 Date: Oct. 19, 2016

(30) Foreign Application Priority Data
Apr. 30, 2014 (DE) 10 2014 208 192.0

(51) Int. Cl. B60R 16/03; B60L 1/00

(52) U.S. Cl. CPC B60R 16/03; B60L 1/00; B60L 2210/10

(57) ABSTRACT

A device for connecting a base vehicle electrical system to a, in particular, safety-relevant subsystem is described, including at least one first switch and one second switch, via which the base vehicle electrical system and the subsystem may be directly coupled; at least one DC-DC converter and a first terminal and a further terminal, the first terminal being electrically contacted between the first switch and the second switch, the further terminal of the DC-DC converter being connectable to the base vehicle electrical system via a third switch, and the further terminal of the DC-DC converter being connectable to an energy store via a fourth switch.

PCT Application WO 2002/080334 A1 describes an integrated starter-generator, for example, a 36V battery, a 12V battery, and a double-layer capacitor are provided. The integrated starter-generator supplies the 42V vehicle electrical system via the connection and supplies the 14V system via a 42/14V converter. Consumers are connected to the systems. The double-layer capacitor may be connected to the integrated starter-generator and the 42V vehicle electrical system via switches. The double-layer capacitor is used only across small voltage ranges, however.

### FIELD

The present invention is directed to a device for connecting a base vehicle electrical system to a, in particular, safety-relevant, subsystem.

### BACKGROUND INFORMATION

### Summary

An object of the present invention is to provide a device and a method for reliably supplying a, in particular, safety-relevant, subsystem with electrical energy.

An example device according to the present invention and an example method according to the present invention may have the advantage over the related art in that a reliable supply, in particular of a safety-relevant vehicle electrical subsystem, takes place. Given that at least one first and one second switch are provided, via which the base vehicle electrical system and the subsystem may be directly coupled, and by providing a DC-DC converter, via which an energy store is to be adapted in terms of its voltage level, if necessary, safety-relevant consumers may be safely and reliably supplied. For this purpose, consumers are preferably subdivided into consumer groups having different safety-relevance. The present invention may be used for the electrical supply of motor vehicles. In addition, the use in other technical areas in which electrical consumers must be supplied with high reliability, is also possible. The present invention also ensures that electrical stores having different voltage levels, such as, for example, double-layer capacitors, may be operated within one vehicle electrical system. In addition, the device according to the present invention and the method according to the present invention prevent safety-relevant and voltage-sensitive consumers from being affected, in terms of their function, by a voltage dip. The device according to the present invention and the method according to the present invention are also distinguished, in particular, by the fact that a dual-channel, electrical supply for redundant, safety-relevant consumers becomes possible. Likewise, an error-tolerant supply for safety-relevant consumers, which are simply present, may take place. The configurability of the electrical supply in the event of an error is possible.

The system is distinguished by high flexibility. Highly diverse operating states may be optimized. For example, consumers or groups of consumers may be decoupled in the event of an error. It is also possible that different electrical energy stores may be operated in a vehicle electrical system via a galvanic separation. In addition, a compensation of voltage dips may take place in the case of voltage-sensitive consumers. The support of the vehicle electrical system is also ensured during the operation of high-load consumers having high current dynamics. A scalable and modular design of the device contributes to cost reductions. In addition, the device may be implemented as special equipment, in particular, in a vehicle.

In advantageous refinements, different operating modes of the device are possible. As a result, further additional functionalities are generated. For example, the device may carry out the store management of the energy store, for example, a double-layer capacitor, with suitable control, for example. This energy store may be charged or discharged with the aid of the device independently of the generator voltage or the voltage of the energy store of the base vehicle electrical system.

In one advantageous refinement, the corresponding control ensures that either only the base vehicle electrical system or only the subsystem or the entire vehicle electrical system of the vehicle may be supported in order to prevent a voltage dip, for example, during the starting process.

In one advantageous refinement, it is provided that a decoupling of the safety-relevant subsystem from the base vehicle electrical system take place and the supply from the energy store is ensured. This increases safety in the event of an error.

In one advantageous refinement, it is provided that, with a suitable control, the decoupling of the subsystem and the support of the base vehicle electrical system may take place from the energy store. This may be necessary, in particular, if a short circuit has occurred in a consumer.

In one advantageous refinement, it is provided that the energy store is decoupled from the safety-relevant subsystem and the supply of the safety-relevant subsystem may take place from the base vehicle electrical system via a direct galvanic coupling. The security of the system is further increased as a result.

In one advantageous refinement, it is provided that the supply of the safety-relevant subsystem may take place from the base vehicle electrical system via the DC-DC converter for the purpose of voltage adaptation. Voltage-critical consumers are therefore supplied in a particularly suitable way.

In one advantageous refinement, it is provided that the entire vehicle electrical system is supported from the energy store without the use of a DC-DC converter. This likewise contributes to the increase in the availability of the entire vehicle electrical system.

Further advantageous refinements result from the description are described herein.

### BRIEF DESCRIPTION OF THE DRAWINGS

One exemplary embodiment of the device according to the present invention for connecting a base vehicle electrical system to a safety-relevant subsystem is represented in the figures and is described in greater detail below.

FIG. 1 shows a block diagram of the exemplary embodiment of the base vehicle electrical system which is connected to the safety-relevant subsystem via a multifunction module, having the appropriate control of the consumers.

FIG. 2 shows the multifunction module in a state in which the energy store is being charged and the subsystem is directly coupled to the base vehicle electrical system.

FIG. 3 shows the multifunction module in a state in which the multifunction module supports the base vehicle electrical system and the subsystem with the aid of the energy store.

FIG. 4 shows the multifunction module in a state in which the multifunction module ensures the supply of the subsystem only from the energy store.

FIG. 5 shows the multifunction module in a state in which the subsystem is decoupled and the base vehicle electrical system is supported by the energy store.

FIG. 6 shows the multifunction module in a state in which the subsystem is decoupled and the energy store is being charged with the aid of the base vehicle electrical system.

FIG. 7 shows the multifunction module in a state in which the multifunction module supports the subsystem only with the aid of the base vehicle electrical system.

FIG. 8 shows the multifunction module in a state in which the multifunction module supports the base vehicle electrical system directly with the aid of the energy store.

FIG. 9 shows the multifunction module in a state in which the multifunction module supports the base vehicle electrical system and the subsystem directly with the aid of the energy store.

FIG. 10 shows the multifunction module in a state in which the multifunction module supports the subsystem only with the aid of the base vehicle electrical system.

FIG. 11 shows a block diagram of an alternative embodiment of the topology according to FIG. 1, the base vehicle electrical system being coupled to a high voltage vehicle electrical system.

### DETAILED DESCRIPTION OF EXAMPLE EMBODIMENTS

A base vehicle electrical system 10 includes at least one starter 12, a generator 14, an energy store 16, and a consumer 18, which is indicated by way of example and which is designed as a so-called comfort consumer. Starter 12, generator 14, energy store 16, and consumer 18 are each connected to ground, in parallel to one another. These components are part of a base vehicle electrical system 10, which is operated at 14V, for example, in the motor vehicle. Safety-relevant consumers 22, 24 are suitably interconnected, as described in the following, in a safety-relevant subsystem 20 in such a way that an energy supply for safety-relevant consumers 22, 24 reliably takes place also in the event of an error. Safety-relevant subsystem 20 may be subdivided into a first safety-relevant subsystem 20a which is supplied from the multifunction module 30 via a second path 23 and which is decouplable from base vehicle electrical system 10 via a switch 26. A second safety-relevant subsystem 20b, as a further part of safety-relevant subsystem 20 is directly connected to base vehicle electrical system 10 via a first path 21. Particularly essential consumers 22 are redundantly designed. Redundant consumers 22a, 22b are each connected to ground. Redundant consumer 22b is supplied directly by base vehicle electrical system 10 via first path 21 and is part of second safety-relevant subsystem 20b. The other redundant consumer 22a, as part of safety-relevant subsystem 20, is supplied via a multifunction module 30. Multifunction module 30 is connected to base vehicle electrical system 10 via a connection path 11. Safety-relevant subsystem 20a is connected to multifunction module 30 via second path 23. In addition, a consumer 24 to be supplied in an error-tolerant way is provided in subsystem 20; the consumer is not redundantly designed, however. A suitable arrangement of switches 26, 28 ensures that both consumer 24 to be supplied in an error-tolerant way and first redundant consumer 22a may be supplied both via base vehicle electrical system 10 and via multifunction module 30. For this purpose, switch 28 may connect consumer 24 to be supplied in an error-tolerant way to the output of multifunction module 30. Further switch 26 is situated between first path 21 and the shared potential of switch 28 and consumer 24 to be supplied in an error-tolerant way. One terminal of multifunction module 30 lies on the potential of base vehicle electrical system 10, i.e., for example, at 14V, via connection path 11. A DC-DC converter 32 is situated in multifunction module 30. DC-DC converter 32 is preferably designed as a 3-way DC-DC converter. A third output is connected to a further energy store 40. Energy store 40 is connected to ground. For example, a double-layer capacitor or a battery having a suitable voltage response may be used as energy store 40.

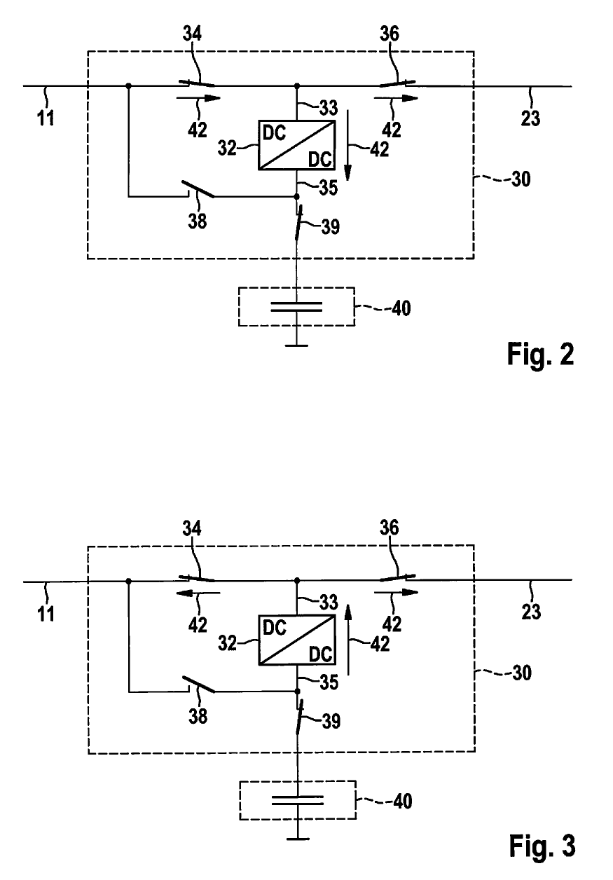

The design of multifunction module 30 is shown in greater detail in FIG. 2. A first switch 34 and a second switch 36, which are connected in series, are provided in multifunction module 30. One terminal 33 of DC-DC converter 32 is contacted between first switch 34 and second switch 36. A further terminal 35 of DC-DC converter 32 may be connected to energy store 40 via a fourth switch 39. First switch 34 may establish the connection between DC-DC converter 32 and base vehicle electrical system 10 via connection path 11. Second switch 36 may establish the connection between DC-DC converter 32 and subsystem 20 via second path 23. In addition, a third switch 38 is provided between the base vehicle electrical system-side input of multifunction module 30, namely connection path 11, and further terminal 35 of DC-DC converter 32.

The exemplary embodiment according to FIG. 2 shows a state in which energy store 40 is being charged. For this purpose, first switch 34 and fourth switch 39 are closed. An energy flow 42, which is indicated by a corresponding arrow, is intended to symbolize that base vehicle electrical system 10 is providing energy via DC-DC converter 32 into energy store 40. DC-DC converter 32 is capable, in accordance with ascertained current and/or voltage values in base vehicle electrical system 10 or at energy store 40, of bringing energy store 40 to a desired voltage level according to selected charging strategies. Energy store 40 may be charged or discharged with the aid of multifunction module 30 independently of the generator voltage or the voltage at energy store 16 of base vehicle electrical system 10. This is ensured via the suitable use of DC-DC converter 32, because the voltage at energy store 40 may differ greatly from base vehicle electrical system 10, depending on the charge. In the control of switch 34, 36, 38, 39 shown in FIG. 2, first subsystem 20a, including safety-relevant consumers 22a, 24, is also directly coupled to base vehicle electrical system 10. Therefore, energy flow 42 from base vehicle electrical system 10 via first switch 34 and second switch 36 also takes place into first subsystem 20a.

FIG. 3 now shows the operation which is the reverse of that shown in FIG. 2. In that case as well, all switches 34, 36, 39, except for third switch 38, are closed. Now, however, DC-DC converter 32 controls energy flow 42 from energy store 40 both via connection path 11 into base vehicle electrical system 10 and via second path 23 into subsystem 20a. Energy store 40 therefore supports both systems 10, 20a. This may occur, for example, if the voltage temporarily dips to, for example, 9V due to the starting process of the internal combustion engine, but safety-relevant consumers 22, 24 must not be affected by this voltage dip such as, for instance, being subject to an impending reset. Other scenarios are simultaneous interventions by electrical steering, the electronic stability program, or electronic brake boosters, which may likewise temporarily cause very high current dynamics.

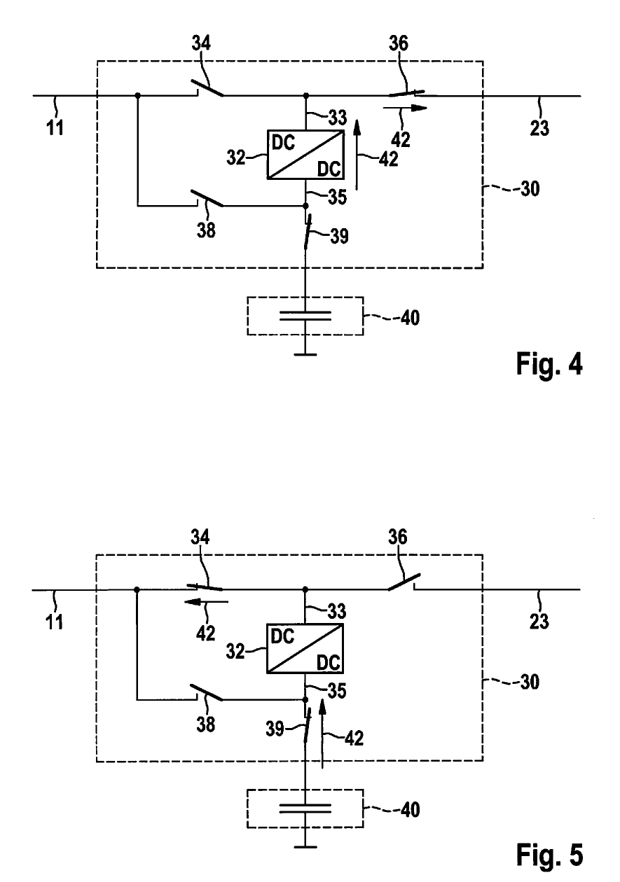

In the control according to FIG. 4, first switch 34 and third switch 38 are now opened. Second switch 36 and fourth switch 39 are closed. In this operating mode, first subsystem 20a is supplied only from energy store 40 via second path 23. For this purpose, DC-DC converter 32 adjusts the voltage ratios in such a way that an energy flow 42 from energy store 40 via DC-DC converter 32 and closed second switch 36 takes place only into subsystem 20. The task of energy store 40 in this case is to supply first subsystem 20a, including safety-relevant consumers 22a, 24, via DC-DC converter 32 when, for example, a failure or a malfunction of base vehicle electrical system 10 takes place.

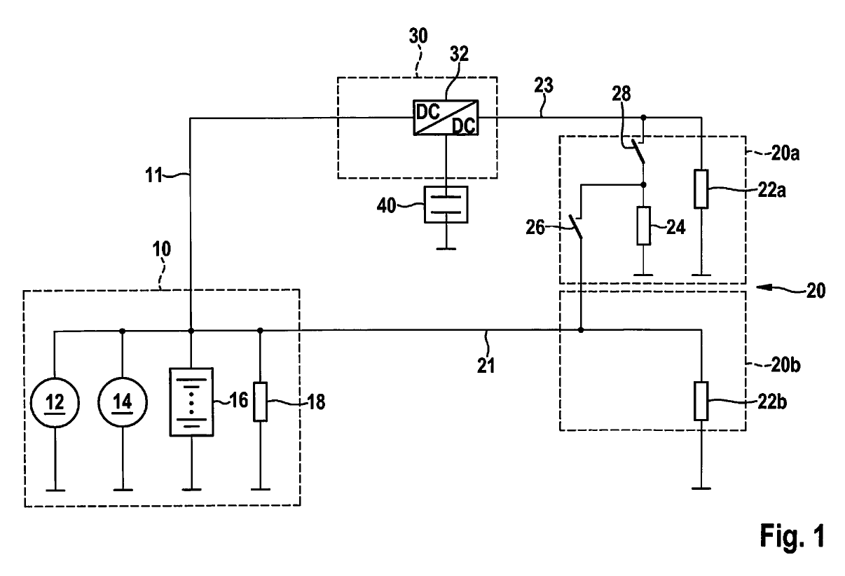

The exemplary embodiment according to FIG. 5 shows the case in which first subsystem 20a must be decoupled, for example, in the event of a short circuit in a consumer 22a, 24 in first subsystem 20a. For this purpose, second switch 36 and third switch 38 are opened. Energy store 40 supports base vehicle electrical system 10 via DC-DC converter 32 or may supply the base vehicle electrical system, for example, in the event of failure of generator 14 and/or energy store 16. For this purpose, switch 26 from FIG. 1 is also closed and switch 28 is opened in order to achieve a complete decoupling of first subsystem 20a and second path 23, respectively.

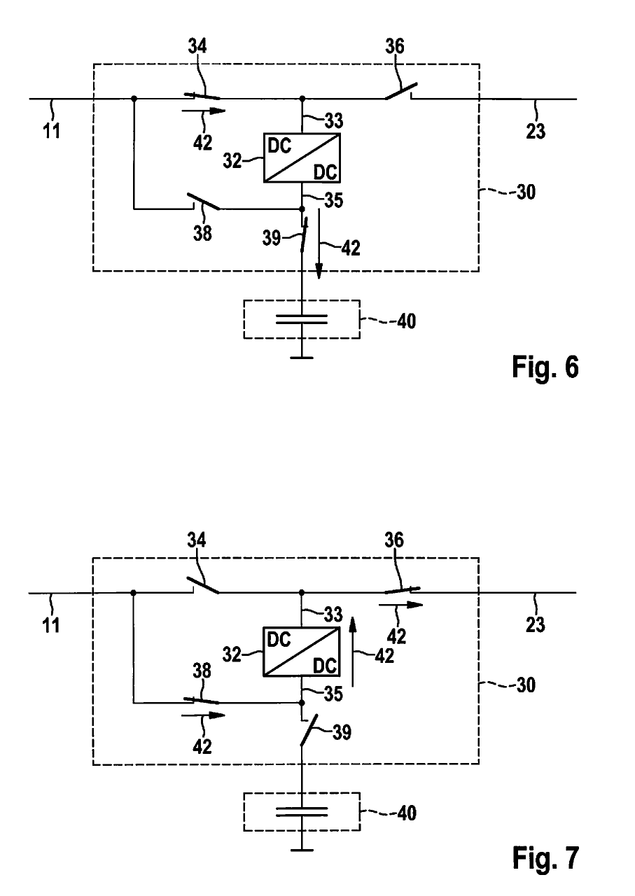

In the exemplary embodiment according to FIG. 6, first switch 34 and fourth switch 39 are closed. Second switch 36 and third switch 38 are opened. In this state, second path 23 is again decoupled. Energy store 40 is being charged by base vehicle electrical system 10 via connection path 11, first switch 34, DC-DC converter 32, and fourth switch 39.

In the exemplary embodiment according to FIG. 7, first switch 34 and fourth switch 39 are opened. Second switch 36 and third switch 38 are closed. In this control of multifunction module 30, second path 23 is supported only by base vehicle electrical system 10. This is advantageous, in particular, for cases in which an undervoltage is present in base vehicle electrical system 10, energy store 40 has been discharged, but second path 23 or first subsystem 20a, including safety-relevant consumers 22a, 24, must be supplied with the nominal voltage. Therefore, corresponding energy flow 42 flows from base vehicle electrical system 10 via third switch 38 and DC-DC converter 32 and via second switch 36 into second path 23.

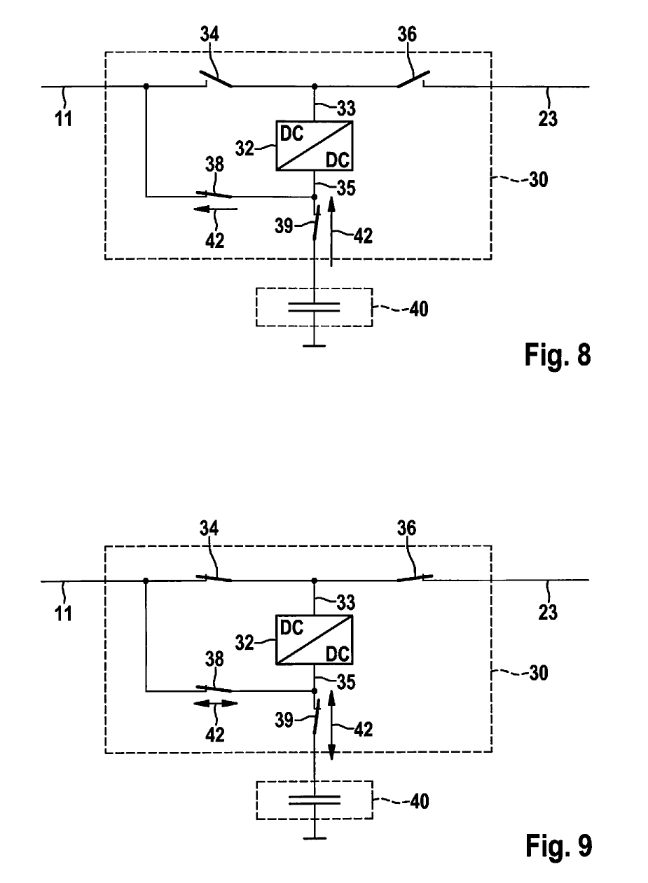

In the control of multifunction module 30 according to FIG. 8, base vehicle electrical system 10 is supported directly by energy store 40 via connection path 11. For this purpose, third switch 38 and fourth switch 39 are closed. First switch 34 and second switch 36 are opened. Second path 23 is decoupled from multifunction module 30. Therefore, base vehicle electrical system 10 is directly connected to energy store 40 without connecting DC-DC converter 32 therebetween. This control is possible when the voltage of energy store 40 lies in the range of base vehicle electrical system 10 and, as described above, temporary current peaks are expected, which energy store 40 may preferably buffer in order to prevent a voltage dip.

In the control of multifunction module 30 according to FIG. 9, both base vehicle electrical system 10 and subsystem 20 may be directly supported by energy store 40. For this purpose, all switches 34, 36, 38, 39 are closed. DC-DC converter 32 is switched to a passive state, however, so that no energy flow 42 takes place via DC-DC converter 32. This switch position is also possible when the voltage of energy store 40 lies in the range of base vehicle electrical system 10 and temporary current peaks are expected, which energy store 40 may buffer in order to prevent a voltage dip.

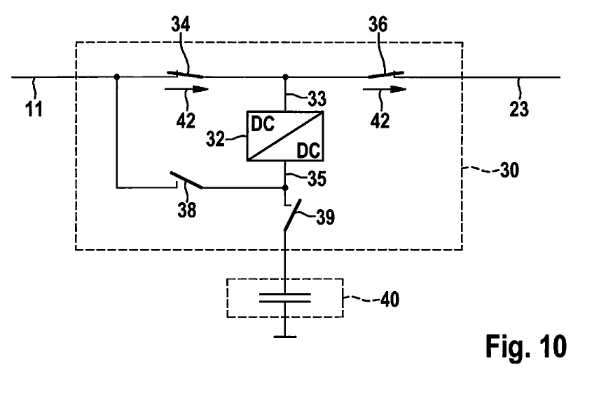

In the control of multifunction module 30 according to FIG. 10, first subsystem 20a and second path 23 is supported only by base vehicle electrical system 10. For this purpose, first switch 34 and second switch 36 are closed. Third switch 38 and fourth switch 39 are opened. Therefore, base vehicle electrical system 10 provides an energy flow 42 in the direction of subsystem 20. Subsystem 20 is therefore directly galvanically coupled to base vehicle electrical system 10; multifunction module 30 and corresponding DC-DC converter 32 are decoupled. For this purpose, DC-DC converter 32 is switched to an inactive state, however, so that no energy flow 42 takes place via DC-DC converter 32.

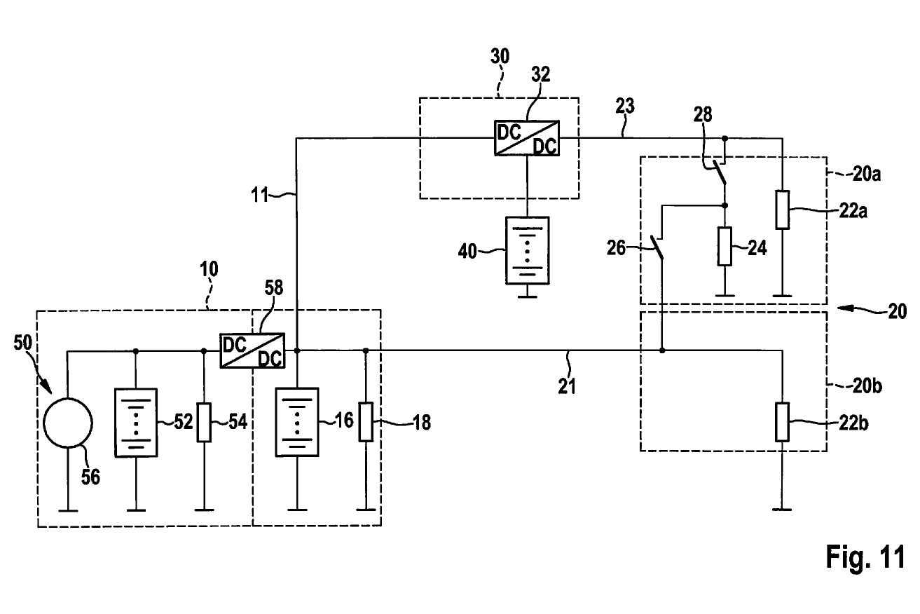

The exemplary embodiment according to FIG. 11 expands upon that from FIG. 1 with a high voltage vehicle electrical system 50 which has a higher voltage level, for example, 48V, as compared to base vehicle electrical system 10. High voltage vehicle electrical system 50 includes a high voltage energy store 52 and a high voltage consumer 54, which is represented by way of example, such as, for example, heating, air conditioning, or the like. In addition, high voltage vehicle electrical system 50 may include an electric machine 56 (e.g., for an electric vehicle, a hybrid vehicle, or a high voltage vehicle electrical system including an electric motor, which assists in regeneration and driving, as part of a so-called boost recuperation system (BRS)). High voltage vehicle electrical system 50 is connectable to base vehicle electrical system 10 via a further DC-DC converter 58. High voltage vehicle electrical system 50 may therefore likewise supply multifunction module 30 and second path 23 via connection path 11. Nothing about the mode of operation of multifunction module 30 changes, however, in principle.

The device was represented, by way of example, using a 14V base vehicle electrical system 10 as an example. Alternatively, generator 14 may also be replaced with an electric machine, which is operable both as a motor and as a generator. Other components, which have another voltage level or also another structure, may also be provided in base vehicle electrical system 10. Subsystem 20 is preferably operated at the same voltage level as vehicle electrical subsystem 10. In this case, it is essential that a reliable supply of safety-relevant components 22, 24 is ensured even in the case of a plurality of above-described error situations. It has been shown that, in the described design of multifunction device 30, a number of operating states which improve the quality of the vehicle electrical system are possible, where a reliable supply of safety-relevant consumers 22, 24 may be ensured in any case.

Due to the described device, it becomes possible to implement a scalable and modular vehicle electrical system topology for supplying safety-relevant electrical consumers 22, 24.

The consumers are subdivided into consumer groups having different safety relevance (cf. redundant consumers 22a, 22b; consumers 24 to be supplied in an error-tolerant way, but which are not intended to be redundantly designed). Safety-relevant subsystem 20 is made up of first subsystem 20a which is decoupleable from base vehicle electrical system 10 at least via switch 26 and multifunction module 30. In addition, safety-relevant subsystem 20 is made of up second subsystem 20b which is always coupled to first base vehicle electrical system 10 via first path 21. This second subsystem 20b preferably contains safety-relevant consumers 22b which are preferably redundantly designed.

Preferably, the device may be used in the motor vehicle sector. In addition, a use in other technical areas, in which electrical consumers must be supplied with high reliability, is also possible. In addition, the device ensures that electrical stores 16, 40 having different voltage levels, in particular in the case of double-layer capacitors, may be operated within one vehicle electrical system. In addition, the function of safety-relevant and voltage-sensitive consumers is prevented from being adversely affected by a voltage dip. In addition, the described topology ensures a dual-channel electrical supply of redundant, safety-relevant consumers 22, 24. Likewise, an error-tolerant supply for safety-relevant consumers 24, which are simply present, is possible. The electrical supply may be flexibly configured in the event of an error. In addition, consumers 22, 24 or groups of consumers may be decoupled in the event of an error. The operation of different electrical energy stores 16, 40 in a vehicle electrical system may be carried out via a galvanic separation by using DC-DC converter 32. In addition, voltage dips may be flexibly compensated for, for voltage-sensitive consumers. In addition, a support of the vehicle electrical system during operation of high-load consumers with high current dynamics is ensured.

The described switches 26, 28, 34, 36, 38, 39 may be, for example, semiconductor switches or conventional relays. Particularly preferably, appropriate switching elements, which are already part of DC-DC converter 32, may also be used when appropriately interconnected in order to carry out the coupling of base vehicle electrical system 10 and/or subsystem 20 and/or energy store 40. As a result, in sum, the number of electronic components of multifunction module 30 could be reduced. FIGS. 2 through 10, which are shown, are used, in particular, for illustrating the different functions of multifunction module 30.

Energy store 16 is, for example, a conventional lead-acid battery, of the kind which is a common integral part of a base vehicle electrical system 10. The characteristic of energy store 40, however, is to be selected in such a way that voltage dips or voltage peaks may be compensated for. A reliable supply of vehicle electrical subsystem 20 also by energy store 40 is of primary importance, however. Preferably, a double-layer capacitor (DLC) or a lithium-ion battery could be used as energy store 40.

The described device is suitable, in particular, in the use of a motor vehicle electrical system, although it is not limited thereto.

1-11. (canceled)

12. A device for connecting a base vehicle electrical system to at least one safety-relevant sub-system, comprising:
at least one first switch and one second switch via which the base vehicle electrical system and the sub-system may be directly coupled;
at least one DC-DC converter including a first terminal and a further terminal, the first terminal being electrically contacted between the first switch and the second switch;
a third switch via which the further terminal of the DC-DC converter may be connected to the base vehicle electrical system; and
a fourth switch via which the further terminal of the DC-DC converter may be connected to an energy store.

13. The device as recited in claim 12, wherein, in a supply of the subsystem, the second and the fourth switches are closed, so that an energy flow from the energy store via the DC-DC converter takes place into the subsystem.

14. The device as recited in claim 12, wherein the first, second, third and fourth switches are closed to support the subsystem, the DC-DC converter being deactivated.

15. The device as recited in claim 12, wherein, in order to support at least the subsystem, at least the second switch and the fourth switch are closed, an energy flow from the energy store also taking place via the DC-DC converter into the subsystem.

16. The device as recited in claim 12, wherein a decoupling of the subsystem takes place by way of the second switch being opened.

17. The device as recited in claim 12, wherein the support of the base vehicle electrical system takes place via the energy store by way of the fourth switch being closed, and at least one of the first switch and the third switch are closed, so that the energy flow takes place at least one of directly and via the DC-DC converter, into the vehicle electrical system.

18. The device as recited in claim 12, wherein the energy store is coupled to at least one of the base vehicle electrical system, and the subsystem, via the DC-DC converter for the purpose of voltage stabilization.

19. The device as recited in claim 12, wherein the base vehicle electrical system includes at least one further energy store, the subsystem includes at least one first safety-relevant subsystem in which safety-relevant consumers are situated, and a second safety-relevant subsystem in which safety-relevant consumers are situated.

20. The device as recited in claim 12, wherein at least one switch is provided for separating or connecting the safety-critical, simply present consumers to at least one of the energy store and the base vehicle electrical system.

21. The device as recited in claim 12, wherein at least two switches are provided, via which at least one consumer situated in the first safety-relevant subsystem may be connected to at least one of the energy store and the base vehicle electrical system.

22. The device as recited in claim 12, wherein at least one of the safety-relevant consumers is redundantly designed, one of the redundant consumers being connected to the base vehicle electrical system without a switch situated therebetween, while the other redundant consumer is connectable to the further energy store.
